(19) United States
(12) Patent Application Publication
(10) Pub. No.: US 2012/0315471 A1
(43) Pub. Date: Dec. 13, 2012

(54) Composites Utilizing Polymeric Capstocks and Methods of Manufacture

(76) Inventors: Douglas Mancosh, Warwick, RI (US); James P. Przybylinski, St. Helena, CA (US)

(21) Appl. No.: 13/495,507

(22) Filed: Jun. 13, 2012

Related U.S. Application Data
(60) Provisional application No. 61/496,273, filed on Jun. 13, 2011.

(51) Int. Cl. B32B 21/02; B32B 27/32; B32B 7/00; B32B 27/20

(52) U.S. Cl. 428/339; 428/532; 428/537.1; 428/507; 428/446; 428/492; 264/174.11

(57) ABSTRACT

An extruded composite adapted for use as a building material includes a core having a base polymer and a filler material in a substantially homogeneous mixture and a polymeric capstock modified with an elastomer and/or a plastomer. To improve adherence of the polymeric capstock to the base polymer, the capstock can include a capstock polymer that is similar or substantially similar the base polymer. Additionally, various additives may be mixed with the capstock material to improve visual aesthetics of the product and performance of the building material, especially over time.

### CROSS-REFERENCE TO RELATED APPLICATIONS

This application claims priority to and the benefit of U.S. Provisional Patent Application Ser. No. 61/496,273, filed on Jun. 13, 2011, the disclosure of which is hereby incorporated by reference herein in its entirety.

### FIELD OF THE INVENTION

This invention relates to systems and methods for fabricating extruded wood-plastic composites and, more particularly, to systems for fabricating extruded wood-plastic composites that include a capstock having an elastomer and/or a plastomer.

### BACKGROUND OF THE INVENTION

In the past 25 years, a new type of material has entered the plastics products market. Commonly referred to as wood-plastic composites (WPCs), fiber-plastic composites, or plastic composites (PCs), the new materials have been accepted into the building products markets in applications such as outdoor decking and railing, siding, roofing and a variety of other products. The market for WPCs has grown, and WPCs are now used in automotive applications, as well as in the building products market, where they compete with wood and other plastic products.

A wood-plastic composite is a blended product of wood, or other natural fibers, and a thermoplastic material. The products can be produced with traditional plastics processes, such as extrusion or injection molding. For example, many building products are produced using extrusion processing similar to conventional plastics processing. The wood and plastics materials are blended before or during the extrusion process. The current WPC materials are most often compounds of wood, or natural fibers, and polyethylene, polypropylene, or polyvinyl chloride (PVC).

Presently available WPCs, however, suffer from certain drawbacks. For example, if the composite contains too high or too low of a ratio of plastic to wood, the finished product may not have the desired visual appearance or structural performance characteristics. Such products are less desirable in the marketplace. Additionally, WPCs may be expensive to produce due to, for example, the high cost of thermoplastic materials and other additives used in manufacture.

Ironically, many consumers expect WPCs to appear similar to wood, but also expect WPCs to perform as a robust plastic compound. To increase performance, manufacturers often incorporate UV stabilizers, antioxidants, biocides, color, fire retardants, or other additives into the WPC formulation. These additives, however, can increase manufacturing costs of the product, even though certain additives provide noticeable benefit only on a limited location on the product (e.g., in the case of UV stabilizers, the benefit only effects the exterior of the product that is exposed to sunlight).

To reduce the amount of additives that are incorporated into the product, capstocking is often used. In general, capstocks are coextruded with the core material to form a thin layer of polymer over the core extruded material. Various additives may be incorporated into the capstock, rather than in the core material, thus reducing the total amount of additives per linear foot of product. These capstocks, however, may suffer from delamination from the underlying WPC and may crack or otherwise fail, causing an unsightly appearance, impaired performance, and consumer dissatisfaction.

With certain capstocks, to improve adhesion, a discrete tie layer is placed between the core material and capstock, but this tie layer can present a number of problems. For example, the bond formed by the tie layer may separate over time from one or both of the capstock and core material, leading to product failure. Bond separation may occur, for example, due to differences in rates of expansion and contraction between the core material and the capstock. Also, water, ice, dirt, pollen, or other materials may penetrate the capstock layer through, for example, gaps at the edges of discrete capstock sections. Additionally, manufacturing costs of capstocked products utilizing a discrete tie layer tend to be high, since the tie layer must be applied to finished capstock and core materials. Another type of capstock material is ionomer-based. See, for example, U.S. application Ser. No. 12/643,442, published as U.S. Patent Application Publication No. 2010/0159213, the disclosure of which is hereby incorporated by reference herein in its entirety.

There is a need for a capstocked WPC that provides improved resistance to moisture, sunlight, delamination, and cracking.

### SUMMARY OF THE INVENTION

Described herein are extruded composite building materials that include a capstock including an elastomer and/or a plastomer. The building materials may be used in a wide range of building products, including decking, siding, trim boards, windows, doors, fencing, and roofing. Compared to previous composite building materials, embodiments of the materials described herein can offer several advantages, including a modified or greater coefficient of friction (i.e., improved slip resistance), improved mechanical resistance to wear, abrasion, scratching and the like (e.g., greater durability or toughness), and improved chemical resistance (e.g., greater resistance to extreme weather, UV, and/or moisture).

In one aspect, the invention relates to an extruded composite adapted for use as a building material. The extruded composite includes a core having a base polymer and a filler material in a substantially homogeneous mixture. The extruded composite also includes a capstock that includes an elastomer and/or a plastomer and is disposed on at least a portion of the core. When the capstock includes the plastomer, then (a) the extruded composite is substantially free of a compatibilizer, and/or (b) when the filler material includes a natural fiber, the natural fiber has or includes a moisture content greater than about 0.5 percent.

In certain embodiments, the base polymer is polypropylene, polyethylene, HDPE, MDPE, LDPE, LLDPE, and/or combinations thereof. The filler material may include natural fiber such as wood chips, wood flour, wood flakes, sawdust, flax, jute, hemp, kenaf, rice hulls, abaca, and/or combinations thereof. In one embodiment, the capstock also includes a capstock polymer, and the capstock polymer and the elastomer and/or the plastomer form or include a substantially homogeneous mixture. The base polymer may include a first polymer (e.g., HDPE) and the capstock polymer may include the first polymer. In some embodiments, the capstock includes an additive that is or includes a colorant, a variegated colorant, a UV stabilizer, an antioxidant, an antistatic agent, a biocide, and/or a fire retardant.

In various embodiments, the core includes from about 35% to about 50% base polymer, by weight. The capstock may include from about 1% to about 30% of the elastomer and/or the plastomer, or from about 5% to about 20% of the elastomer and/or the plastomer, by weight. In some embodiments, the capstock includes from about 70% to about 99% capstock polymer, or from about 80% to about 95% capstock polymer, by weight. A thickness of the capstock may be, for example, from about 0.012 inches to about 0.040 inches, or from about 0.015 inches to about 0.020 inches.

In certain embodiments, the capstock includes the elastomer, and the elastomer includes a propylene based elastomer, an ethylene propylene diene monomer, a three block thermoplastic elastomer, and/or a two block thermoplastic elastomer. In one embodiment, the capstock includes the plastomer, and the plastomer includes very low density polyethylene, metallocene polyethylene, and/or ethylene methacrylate. The filler material may include an inorganic filler (e.g., calcium carbonate, fly ash, and/or talc). The extruded composite may also include crumb rubber (e.g., in the capstock and/or the core).

In another aspect, the invention relates to a method of manufacturing an extruded composite adapted for use as a building material. The method includes the steps of: providing a base polymer; providing a filler material; mixing and heating the base polymer and the filler material to produce a base mixture that is or includes a substantially homogeneous melt blend; providing a capstock material having an elastomer and/or a plastomer; and coextruding the capstock material onto at least a portion of the base mixture through a die to form an extruded profile. When the capstock material includes the plastomer, then (a) the extruded composite is substantially free of a compatibilizer, and/or (b) when the filler material includes a natural fiber, the natural fiber has or includes a moisture content greater than about 0.5 percent.

In certain embodiments, the method includes providing a capstock polymer, and mixing and heating the capstock polymer and the capstock material to produce a capstock mixture that has or includes a substantially homogeneous melt blend. The base polymer may include a first polymer (e.g., polypropylene, polyethylene, HDPE, MDPE, LDPE, LLDPE, and/or combinations thereof) and the capstock polymer may include the first polymer. In one embodiment, the first polymer is HDPE. The method may also include the steps of: providing an additive that is or includes a colorant, a variegated colorant, a UV stabilizer, an antioxidant, an antistatic agent, a biocide, and/or a fire retardant; and mixing and heating the capstock material, the capstock polymer, and the additive to produce a capstock mixture that is or includes a substantially homogeneous melt blend.

In some embodiments, the method includes cooling the extruded profile by passing the extruded profile through a liquid. The coextruding may occur, for example, in a single step from constituent materials. In one embodiment, the capstock material includes the elastomer, and the elastomer includes a propylene based elastomer, an ethylene propylene diene monomer, a three block thermoplastic elastomer, and/or a two block thermoplastic elastomer. Alternatively or additionally, the capstock material may include the plastomer, and the plastomer may include very low density polyethylene, metallocene polyethylene, and/or ethylene methacrylate. The filler material may include an inorganic filler (e.g., calcium carbonate, fly ash, and/or talc). The method may also include the step of providing crumb rubber for incorporation into the base mixture and/or the capstock material.

Herein, unless otherwise noted, the use of one material when describing a particular application, process, or embodiment does not limit the described application, process, or embodiment to the specific material identified. The materials may be used interchangeably, in accordance with the described teachings herein. Additionally, unless otherwise noted, the terms WPCs, PCs, fiber-plastic composites, and variations thereof are used interchangeably.

### BRIEF DESCRIPTION OF THE DRAWINGS

Other features and advantages of the present invention, as well as the invention itself, will be more fully understood from the following description of the various embodiments, when read together with the accompanying drawings, in which:

FIG. 1 is a schematic, perspective view of a capstocked WPC, in accordance with one embodiment of the present invention;

FIG. 2 is a schematic, perspective view of a system for extruding a capstocked WPC, in accordance with another embodiment of the present invention;

FIG. 3 is a cross-sectional schematic representation of a system for extruding a capstocked WPC, in accordance with another embodiment of the present invention;

FIGS. 4A and 4B are schematic representations of a process line for forming a capstocked WPC, in accordance with another embodiment of the present invention;

FIG. 5 is a schematic, end view of a co-rotating twin screw extruder used in a system for forming a capstocked WPC, in accordance with another embodiment of the present invention;

FIG. 6 is a schematic, perspective view of a Y-block adapter and extrusion die assembly used in a system for forming a capstocked WPC, in accordance with another embodiment of the present invention;

FIG. 7A depicts schematic side section and front views of a coextrusion die assembly used in a system for forming a capstocked WPC, in accordance with another embodiment of the present invention;

FIG. 7B depicts schematic inlet, side section, and outlet views of the plates of the coextrusion die assembly of FIG. 7A, in accordance with another embodiment of the present invention;

FIG. 7C depicts enlarged partial side section views of the coextrusion die assembly of FIG. 7A, in accordance with another embodiment of the present invention;

FIG. 8 is a plot depicting a relationship of capstock formulation to adhesion strength, in accordance with another embodiment of the present invention; and

FIG. 9 is a plot depicting a relationship of capstock formulation to slip resistance, in accordance with another embodiment of the present invention.

### DETAILED DESCRIPTION OF THE INVENTION

As used herein, “plastomer” is understood to mean a non-ionomeric copolymer that includes ethylene and/or propylene.

As used herein, “compatibilizer” is understood to mean an agent that has a primary function to improve the wetting of a polymer on a natural fiber, such as wood fiber. Examples of such compatibilizers include titanium alcoholates, esters of phosphoric, phosphorous, phosphonic, and silicic acids, metallic salts and esters of aliphatic, aromatic, and cycloaliphatic acids, ethylene/acrylic or methacrylic acids, ethylene/esters of acrylic or methacrylic acid, ethylene/vinyl acetate resins, styrene/maleic anhydride resins or esters thereof, acrylonitrilebutadiene styrene resins, methacrylate/butadiene styrene resins (MBS), styrene acrylonitrile resins (SAN), and butadieneacrylonitrile copolymers. Other examples of compatibilizers include modified polyethylene and modified polypropylene, which are obtained by modifying polyethylene and polypropylene, respectively, using a reactive group, including polar monomers such as maleic anhydride or esters, acrylic or methacrylic acid or esters, vinylacetate, acrylonitrile, and styrene.

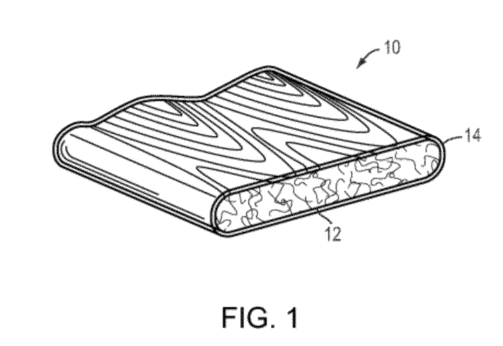

FIG. 1 shows one embodiment of a capstocked extruded wood-plastic composite 10 (WPC) in accordance with the present invention. The extruded WPC 10 generally includes a dimensional composite body or core 12 formed from a mixture including one or more base polymers and natural fibers or other fillers. The base polymers may include polypropylene, polyethylene, HDPE, MDPE, polypropylene, LDPE, LLDPE, like materials, and combinations thereof. The natural fibers or filler materials help to provide the extruded core 12 with the appearance and feel of a natural wood product. Types of natural fibers, such as wood fillers or the like, include wood chips, wood flour, wood flakes, sawdust, flax, jute, abaca, hemp, kenaf, rice hulls, like materials, and combinations thereof. The use of such fillers can reduce the weight and cost of the core 12. Additionally, the core 12 may include additives such as colorants, lubricants, flame retardants, mold inhibitors, biocides, UV stabilizers, antioxidants, antistatic additives (e.g., to reduce dust attraction), other materials, and combinations thereof.

In certain embodiments, the natural fibers have a moisture content from about 0.5% to about 5%. In other embodiments, the moisture content of the natural fibers is from about 1% to about 3%. For example, the moisture content of the natural fibers may be about 2%.

In some embodiments, the natural fibers are replaced by or supplemented with other types of fillers. For example, the core 12 may include inorganic fillers and/or natural or synthetic elastomers in various forms, such as crumb rubber in different grades and mesh sizes, including pulverized crumb rubber. The inorganic fillers may be or may include, for example, calcium carbonate, talc, bottom ash, and/or fly ash. The talc may be, for example, talcum powder. The crumb rubber may have a mesh size ranging from about 4 to about 100, or from about 20 to about 40, or about 30. The crumb rubber may be of any grade, for example from No. 1 to No. 5, or from No. 1 to No. 3, or preferably of grade No. 2 or No. 3. The crumb rubber may be or include any type of rubber, including natural rubber, synthetic rubber, a thermoset, and/or a thermoplastic. For example, the crumb rubber may include SBR, nitrile, or other synthetic variations. The natural fibers and/or other fillers may be dispersed within the core and held in place with the base polymer.

The core 12 is coated at least on one side by a capstock 14 that includes a capstock polymer and an elastomer and/or a plastomer. The capstock polymer may be any polymeric material capable of providing the desired mechanical, chemical, and thermal properties. In certain embodiments, the capstock polymer includes a polyolefin, such as polyethylene and/or polypropylene. In one embodiment, the capstock polymer is polyethylene (e.g., HDPE, product 6007 manufactured by Chevron Phillips).

Similarly, the elastomer may be any type of elastomer that provides the capstock 14 with the desired mechanical, chemical, and thermal properties. Suitable elastomers include propylene based elastomers, ethylene propylene diene monomer (EPDM), three block thermoplastic elastomers (TPEs), and two block TPEs. The propylene based elastomers refer to those propylene products that have been produced using specific molecular architecture and a tightly controlled molecular weight range. This is unlike the modified polypropylenes referred to above as compatibilizers. These compatibilizers are polypropylene molecules that have had maleic anhydride or similar graftings to realize the modification. An example of a propylene-ethylene based elastomer is VERSIFY™, manufactured by Dow Chemical, of Midland, Mich. An example of an EPDM is VISTALON™, manufactured by Exxon Mobil, of Irving, Tex. Examples of three block TPEs are styrene-ethylene/butylene-styrene (SEBS), such as KRATON G, block copolymers of styrene and butadiene, such as KRATON D (SBS), and polymers based on styrene and isoprene, such as Kraton D (SIS), manufactured by Kraton Performance Polymers Inc. of Houston, Tex. A weight percentage of elastomer in the capstock may be between about zero and about 50%, between about 5% and about 30%, between about 10% and about 20%, or about 5%.

Likewise, the plastomer may be any type of plastomer that provides the capstock 14 with the desired mechanical, chemical, and thermal properties. Suitable plastomers include very low density polyethylene (VLDPE), metallocene polyethylene (PE), and ethylene methacrylate (EMA). In one embodiment, the propylene based elastomers, described above, are plastomers, in addition to being elastomers, and are therefore suitable for use in the capstock 14 as a plastomer and/or an elastomer. VLDPE and metallocene PE may be obtained from Dow Chemical or Exxon Mobil. EMA may be obtained from Dow Chemical. A weight percentage of plastomer in the capstock may be between about zero and about 50%, between about 5% and about 30%, between about 10% and about 20%, or about 5%.

In certain embodiments, the base polymer facilitates adhesion between the capstock 14 and the extruded WPC 10, particularly when the base polymer and the capstock polymer are the same (e.g., HDPE). Since polymers such as polyethylene weather rapidly under certain conditions, inclusion of additives and stabilizers also may improve exterior weather performance. The elastomers and/or the plastomers, along with the additives and stabilizers, provide improved surface properties over those of uncoated extruded WPC. The elastomeric and/or plastomeric compound on the surface of the extruded WPC 10 increases scratch resistance, color fade resistance, and stain resistance, as shown in a number of controlled tests. The elastomer and/or plastomer capstock also reduces damage to the WPC 10 from water at high and low temperatures.

WPCs need not be completely surrounded by capstock to benefit from the advantages associated therewith, however. In some embodiments, it may be desirable to coextrude a capstock onto fewer than all surfaces of a core profile, for example, on only those surfaces subject to the most severe environmental exposure (e.g., an upper horizontal surface and optionally vertical edges of extruded deckboards).

As noted above, in certain embodiments, the capstock polymer is substantially the same as or identical to the base polymer utilized in the core 12. For example, both the capstock polymer and base polymer may be polyethylene. Alternatively, a polyethylene capstock polymer may be used in conjunction with a polypropylene base polymer. Use of polypropylene capstock polymers in conjunction with polyethylene base polymers, as well as other combinations of dissimilar polymers, is also contemplated. In one embodiment, similarity between the capstock polymer and the base polymer helps ensure adhesion between the core 12 and the capstock 14. Additionally, the capstock 14 may include natural fibers, inorganic fillers, crumb rubber, and/or additives, such as those listed above with regard to the core 12. By incorporating the natural fibers, inorganic fillers, crumb rubber, and/or additives into the capstock 14 instead of the core 12, the total amount of natural fibers, inorganic fillers, crumb rubber, and/or additives per linear foot of extruded composite may be significantly reduced (e.g., compared to composites that have these materials incorporated only in the core). Note that inclusion of certain materials in the capstock 14 (e.g., natural fibers) can compromise certain performance characteristics (e.g., stain resistance and/or fading), depending on the composition and application of the building material.

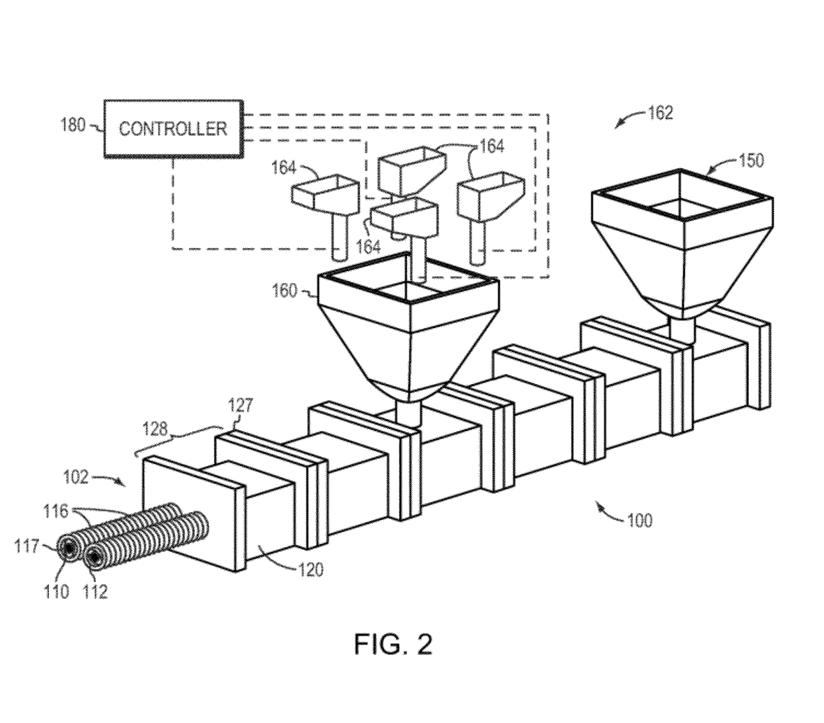

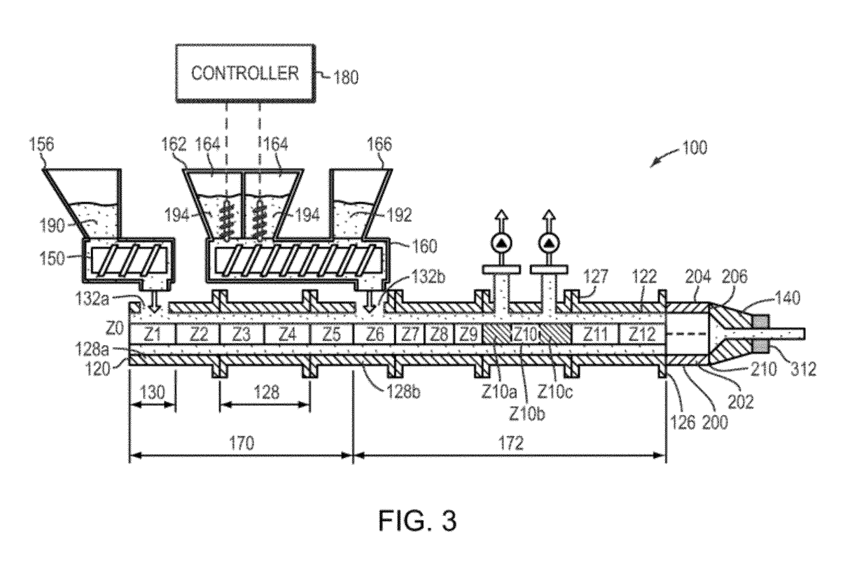

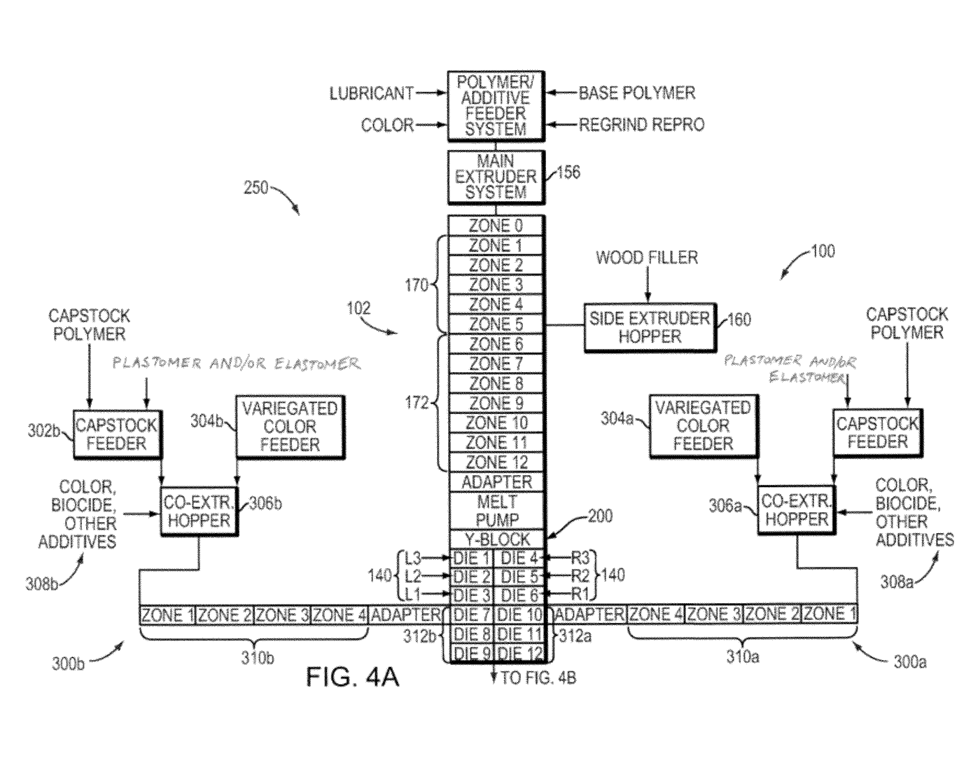

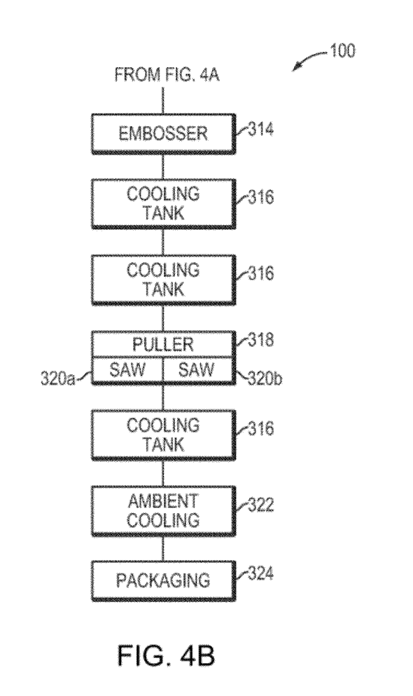

In certain embodiments, the invention includes systems and methods for forming plastic composite extrusions having a coextruded capstock that includes an elastomer and/or a plastomer. As shown in FIGS. 2 and 3, an extrusion system 100 includes at least four main stations: a supply station or primary feeder 150 that dispenses a base polymer (e.g., in the form of powders and/or pellets) and other additives; a co-rotating twin screw extruder 102 arranged to receive the base polymer; a secondary side-feeder 160 that dispenses additional materials (e.g., filler materials such as wood or natural fibers, additives such as colorants, etc.) into the extruder 102 for mixing with the base polymer; and an extrusion die 140 for forming a composite extrusion with a predetermined profile. FIGS. 4A and 4B, described in more detail below, depict the extrusion system 100 of FIGS. 2 and 3, with two co-extrusion stations and related downstream components for manufacturing finished capstocked WPCs.

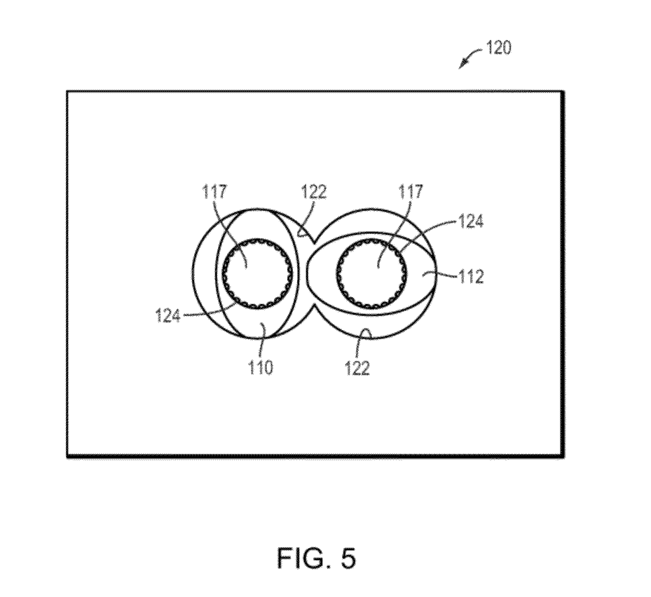

In the extrusion system 100 depicted in FIG. 2, the extruder 102 includes an extrusion barrel 120 and a pair of co-rotating extrusion screws 110, 112. The extrusion barrel 120 defines an internal cavity 122 (FIG. 5) where materials (e.g., base polymer, filler materials, additives, etc.) are mixed, heated, and conveyed. The extrusion barrel 120 is formed as an assembly including a plurality of discrete barrel segments 128. The barrel segments 128 are arranged in series and together form the internal cavity 122, which acts as a flow path between the supply station 150 and the extrusion die 140 (i.e., for conveyance of the various materials). The extrusion screws 110, 112 each comprise a plurality of discrete screw segments 116 sealed within the internal cavity 122 and extending from an upstream feed zone 130 to the extrusion die 140. The screw segments 116 are removable, replaceable, and interchangeable and the screw flights can be arranged to achieve a desired feeding, conveying, kneading, and mixing sequence as the materials are processed through the extruder, along the internal cavity 122 of the extrusion barrel 120.

The extrusion screws 110, 112 are arranged in parallel relation and configured for co-rotational movement relative to each other. The co-rotational movement of the extrusion screws 110, 112 mixes materials, such as the base polymer, wood fiber, additives, etc., and conveys these materials through the extrusion barrel 120. The extrusion barrel 120 and extrusion screws 110, 112 can be made of commercially available parts. A similar type of twin-screw extruder, wherein the screws rotate in a counter-rotational movement relative to each other, may also be used for the process. In a counter-rotational arrangement, the process differs from the above co-rotational configuration in that the mixing and dispersion tend to be less intense. Thus, a greater reliance is placed on the addition of heat, as opposed to shear mixing, to achieve the compounding of all the ingredients prior to passage through the extrusion die 140.

As shown in FIGS. 2 and 3, the extrusion system 100 includes at least four main stations: a supply station 150; a co-rotating twin screw extruder 102; a secondary side-feeder 160; and an extrusion die 140. The supply station 150 can include a single and/or double screw (i.e., twin-screw) loss-in-weight gravimetric feeder for throughput of solid materials, typically in the form of fibers, powders, and/or pellets, into a feed zone 130 in the extruder 102. A loss-in-weight feeder or feeders with a maximum feed rate of between about 50 lb/hr and about 2000 lb/hr may be utilized for typical commercial-sized system. The feeder(s) also deliver materials directly into the extruder when the process is initially started.

Referring still to FIGS. 2 and 3, the twin screw extruder 102 includes an extrusion barrel 120 and a pair of co-rotation extrusion screws 110, 112. The extrusion barrel 120 is an assembly of discrete barrel segments 128 forming a substantially continuous barrel. This arrangement offers flexibility when compared to a counter-rotational extruder, in that the individual barrel segments 128 can be moved, removed, and/or exchanged to provide different barrel configurations, e.g., to allow for different feeding (e.g., entry ports), vacuum, or injection locations. In addition, the segmented barrel configuration offers the flexibility of choosing between multiple entry ports (for example, as shown at 132a, 132b) into the extruder 102. For example, the use of more than one entry port can be employed to achieve a more sophisticated extruded product in terms of compound ingredients, product properties, and appearance. Each barrel segment 128 defines a barrel bore which, when assembled, forms a substantially continuous internal cavity 122 along the length of the extrusion barrel 120 (i.e., extending from the feed zone 130 toward the extrusion die 140). Each barrel segment 128 includes electrical heating elements, such as heating cartridges, and cooling bores for counter-flow liquid cooling, together providing for optimizeable dynamic regulation and control of temperature.

Individual barrel segments 128 are selected from open barrels (i.e., with entry ports for feed zones), open barrels with inserts (for degassing, metering, or injection zones), closed barrels, and/or combined barrels for combined feeding (e.g., side feeding of fibers or additives) and venting, each being between about four inches and about twenty inches in length. As shown in FIG. 3, the extrusion barrel 120 includes two open barrel segments 128a, 128b for fluid communication with the primary feeder 150 and the secondary side-feeder(s) 160, respectively. A leak-proof seal is formed at the interface between adjacent barrel segments 128. Adjacent barrel segments 128 can be connected with bolted flanges 127, as shown in FIG. 2, or, alternatively, C-clamp barrel connectors.

Referring to FIG. 2, the co-rotating extrusion screws 110, 112 provide for a relatively efficient type of extruder in terms of its ability to disperse and distribute additions and other materials within a matrix of the molten extrudate. As shown, each of the extrusion screws 110, 112 comprises a segmented screw arrangement, wherein each of the extrusion screws 110, 112 include a series of discrete elements or flights (i.e., screw segments 116) fit onto a shaft 117. Teeth or splines 124 (see FIG. 5) allow the individual segments 116 to be secured to the shaft 117. Suitable screw segments are commercially available from ENTEK Manufacturing, Inc., of Lebanon, Oreg. The individual screw segments 116 are each removable and replaceable and may be selected to have contrasting screw profiles, thus allowing for a flexible screw profile arrangement that can be tailored to specific applications and/or process requirements.

Among the various types of screw segment profiles, the individual segments can be selected from conveying elements, mixing elements, kneading elements, and/or special elements. Mixing and kneading elements are designed in a variety of lengths, pitches and pitch directions. Kneading blocks are constructed using several sub-segments of equal or varying widths spaced at equal distances from each other. The order in which kneading, mixing, conveying, and other segments may be arranged to control shear, the degree of melt, and energy addition. In addition, this mixing process provides homogeneous melt and controlled dispersion-distribution of the base polymer and other additives. The segmented screws 110, 112 allow for modification of the screw profile, e.g., for modification of processing parameters, varying physical properties, and/or surface appearance of the extruded product. Generally, an overall diameter of the screw segments remains constant; however, the shape of the flights (e.g., pitch and distance between flights) can vary.

The screw segments 116 can be arranged so that about a first half of the extruder 102 provides relatively high shearing and kneading (i.e., for dispersive mixing of the base materials and any additives) and about the second half of the extruder 102 provides relatively low shearing (i.e., for distributive mixing of the composite material and colorants or other additives). This arrangement can be used to inhibit overmixing of the one or more polymers and additives that form the polymeric portion of the composite material.

FIGS. 3, 4A, and 4B depict an exemplary embodiment of the manufacturing equipment. Each of extrusion screws 110, 112 includes fifty-two (52) discrete screw segments 116, each between about 60 mm and about 120 mm in length. This particular configuration defines twelve (12) processing zones Z1-Z12, each zone exhibiting a change in screw profile defined by one or more discrete screw segments (see, e.g., FIGS. 3, 4A, 4B, and Table A-1). In this embodiment, the screw segments 116 are arranged such that the first five zones (Z1-Z5) form a first mixing region 170 configured for dispersive mixing (i.e., relatively high kneading and shearing), and the last seven zones (Z6-Z12) form a second mixing region 172 configured for distributive mixing (i.e., relatively low shearing). In dispersive mixing, cohesive resistances between particles can be overcome to achieve finer levels of dispersion; dispersive mixing is also called intensive mixing. In other words, dispersive mixing includes the mixing and breaking down of discrete particles within the compound. Distributive mixing aims to improve the spatial distribution of the components without cohesive resistance playing a role; it is also called simple or extensive mixing. Distributive mixing allows for division and spreading of discrete particles into a mixture without substantially affecting the size and/or shape of the particles (i.e., no breaking down of the particles).

FIGS. 4A and 4B are schematic representations of a process line 250 for forming a capstocked WPC in accordance with one embodiment of the invention. Depicted is the extruder 102, as well as a pair of capstock extruders 300a, 300b, and various components downstream of the profile extrusion system 100 depicted in FIGS. 2 and 3. Each capstock extruder system 300 includes a capstock feeder 302 and a variegated color feeder 304 that each deliver desired quantities of components to a coextrusion hopper 306. The capstock feeder 302 is filled with a mixture of elastomer and/or plastomer (plus additives, if desired) and capstock polymer, in any ratio desired or required for a particular application. This mixture may be delivered premixed to the feeder 302 or may be introduced to the feeder 302 via two hoppers. Additional additives may be introduced to the hopper 306 via one or more additive feeders 308. The additives may include colors, biocides, flame retardants, UV inhibitors, etc.

Each coextruder body 310 includes, in the depicted embodiment, four zones (Z1-Z4) and connects to a coextrusion die 312 at the outlet of the core extrusion die 140. The coextruder 310 may be either a single-screw or twin-screw configuration. Process parameters associated with the capstock extruder 300 are presented in Table A-1. In the depicted embodiment, unlike the extruder 102, the extruder body 310, the screw and barrel are not segmented. Additionally, the screw profile is not designed for mixing, but rather for melting and conveying. In other embodiments, different types of extruders using segmented barrels or screws may be utilized. In certain embodiments, output from each coextruder body 310 is about 125 lb/hr to about 175 lb/hr. If a single capstock coextruder is utilized, the output may be between about 250 lb/hr to about 400 lb/hr. Other outputs are contemplated, depending on configurations of particular process lines, surface area and thickness of the capstock layer, etc. In general, the coextruder output represents about 5% of the total output of the system 100. After extrusion, the extruded, capstocked composite may be decorated by an embosser 314, if desired, and passed through one or more cooling tanks 316, which may be filled with a liquid such as water and/or coolant, to expedite cooling. Optional sizing dies of the vacuum type or other types may be used during cooling to maintain dimensional requirements for he composite. A puller 318 is used to pull the extruded composite through the cooling tanks 316 and sizing dies to maintain dimensional consistency of the product as it is cooled. One or more saws 320 cut the finished extruded composite prior to a final ambient cooling station 322 and a packaging station 324.

Other embodiments of the process line 250 depicted in FIGS. 4A and 4B are contemplated. For example, a single coextruder 310 may be utilized to feed molten capstock material to both coextrusion dies 312a, 312b. The depicted co-extruder system may be particularly desirable, however, allowing capstocks of different formulations to be applied to different surfaces of the extruded WPC, or to permit quick changeover of capstock material to be applied to same batch of core material. This allows for production of capstocked WPCs of different colors, for example.

As depicted in FIG. 4A, in certain embodiments, the core and capstock are formed in a single step by simultaneously coextruding the core and the capstock from constituent materials in multiple extruders, without pre-pelletizing the core materials or capstock materials. In alternative embodiments, the core materials and/or capstock materials can be pre-pelletized, to support a multi-step process.

Table A-1 identifies typical zone temperatures and other details regarding the extruder processing system employed in the various embodiments of the invention. Temperatures for each zone, in a high/low range, are presented. Notably, the ranges presented may be utilized to produce both capstocked and uncapstocked WPCs. Additionally, the ranges presented may also be utilized to produce composites that utilize no wood or natural fibers at all, but that are made solely of additives and base polymer. Examples of both capstocked and uncapstocked WPCs manufactured in accordance with the ranges exhibited in Table A-1 are described below. Temperature and other process parameter ranges outside of those depicted are also contemplated.

TABLE A-1
Processing Parameters for Coextruded Capstocked Composites
MAIN EXTRUDER

| | Melt Pump Inlet | | Melt Pump Outlet | | Extruder | Melt | Polymer | Wood | Added |
|---|---|---|---|---|---|---|---|---|---|
| | Mat'l Temp | Pressure | Mat'l Temp | Pressure | Speed | Pump | Feed | Feed | Wax |
| | deg C. | Bar | deg C. | Bar | rpm | rpm | lb/hr | lb/hr | lb/hr |
| High | 180 | 30 | 185 | 80 | 350 | 25 | 2000 | 2000 | 10 |
| Low | 140 | 7 | 140 | 10 | 250 | 15 | 700 | 800 | 0 |

| | Zone 0 | Zone 1 | Zone 2 | Zone 3 | Zone 4 | Zone 5 | Zone 6 | Zone 7 | Zone 8 | Zone 9 | Zone 10 | Zone 11 | Zone 12 |
|---|---|---|---|---|---|---|---|---|---|---|---|---|---|
| | Set | Set | Set | Set | Set | Set | Set | Set | Set | Set | Set | Set | Set |
| | deg C. | deg C. | deg C. | deg C. | deg C. | deg C. | deg C. | deg C. | deg C. | deg C. | deg C. | deg C. | deg C. |
| High | 60 | 240 | 240 | 240 | 240 | 190 | 180 | 165 | 155 | 150 | 150 | 150 | 150 |
| Low | 30 | 190 | 190 | 190 | 190 | 180 | 170 | 155 | 145 | 130 | 125 | 115 | 110 |

| | Adapter | Melt Pump | Y-block 1 | Y-block 2 | Y-block 3 | Die L1 | Die L2 | Die L3 | Die R1 | Die R2 | Die R3 |
|---|---|---|---|---|---|---|---|---|---|---|---|
| | Set | Set | Set | Set | Set | Set | Set | Set | Set | Set | Set |
| | deg C. | deg C. | deg C. | deg C. | deg C. | deg C. | deg C. | deg C. | deg C. | deg C. | deg C. |
| High | 165 | 165 | 165 | 165 | 165 | 165 | 165 | 165 | 165 | 165 | 165 |
| Low | 140 | 140 | 140 | 140 | 140 | 140 | 140 | 140 | 140 | 140 | 140 |

CO-EXTRUDER

| | Extruder | Zone 1 | Zone 2 | Zone 3 | Zone 4 | Adapter |
|---|---|---|---|---|---|---|
| | Speed | Set | Set | Set | Set | Set |
| | rpm | deg C. | deg C. | deg C. | deg C. | deg C. |
| High | 130 | 180 | 190 | 190 | 200 | Ambient |
| Low | 30 | 130 | 140 | 150 | 160 | Ambient |

With regard to the main extruder, in general, conveying and feed elements (e.g., Z1, Z2, Z4, Z6, Z8, Z10, and Z12) serve to displace material through the extrusion barrel 120, from the first entry port 132a toward the extrusion die 140. Kneading blocks (see, e.g., Z3 and Z6) provide for high shear and dispersing (e.g., of base materials). Mixing elements (see, e.g., Z7, Z9, and Z11) provide for relatively high particle distribution (e.g., high distribution of fiber materials). Zones having a flight pitch less than 90° provide for compression of materials. Zones having a flight pitch of about 90° provide for frictional heating of the materials while providing little if any aid in the conveyance of the material. Zones having a flight pitch exceeding 90° provide for relatively high conveyance.

Referring to FIGS. 3-5, and Table A-1, zone Z0 is the ambient temperature. Zones Z1 and Z2 are configured for moving materials from the throat of the extruder 102 and heating it before it is introduced to zone Z3. More specifically, the first processing zone Z1 is configured to move cold material, e.g., pelletized base polymers, from an entry point at ambient temperature, i.e., main entry port 132a, toward the second processing zone Z2. The second processing zone Z2 is configured to increase pressure on the material as it is moved forward in the direction of the third processing zone Z3. The first eight to twenty-four segments making up the second processing zone Z2 have a flight pitch of about 90°. In this portion, conveyance is achieved primarily through the introduction of additional material from the first processing zone Z1, which results in the build up of pressure in the second processing zone Z2, which, in turn, forces the material through the second processing zone Z2.

Processing zones Z3-Z5 define a high shear section. In this section the base materials are thoroughly dispersed into a molten composite mixture. Zone Z6 marks a transition to the distributive mixing region 172. This is the zone in which the wood or other natural fibers (as fillers) and some additives are added to the molten composite mixture. The greater flight pitch of 120° in this zone provides for increased conveyance along or about zone Z6, i.e., this zone moves materials along quickly, thereby inhibiting cooling-off of the materials. Zones Z7-Z9 are configured to provide high distribution mixing of the fiber filler material with the molten composite mixture. The tenth processing zone Z10 includes six to twelve discrete screw segments. These segments define a first section Z10a of relatively high compression, followed by a section Z10b of relatively low conveyance, which allows the material to expand, allowing moisture to rise to the outer surface where it can evaporate and be vented from the extrusion barrel 120. This is followed by a second section Z10c of relatively high compression.

The eleventh processing zone Z11 is a mixing zone with a relatively high flight pitch, which provides for increased conveyance and subtle mixing. The twelfth processing zone Z12 transitions from a first section of relatively high conveyance (i.e., this zone moves material at a relatively high flow/feed rate to inhibit cooling prior to entering the die) to a second section of relatively high compression, which provides for a build-up of pressure near the distal end 126 of the extruder 102, for forcing the material through the extrusion die 140.

Referring again to FIGS. 2-4, one or more secondary side-feeders 160 are provided for dispensing one or more additional materials (e.g., filler materials or natural fibers, colorants, and/or other additives) into the extrusion barrel for mixing with the base polymer. As described herein, providing these additives in the capstock material instead of the core material may be desirable and reduce the total amount of additives added per linear foot of extruded composite. It may be desirable or required to include additives within the core material to meet certain requirements (e.g., the addition of additives such as fire retardants to meet particular product safety regulations). The secondary side-feeders 160 move the materials into the extruder 120 through a second side entry port 132b using a single-screw or double-screw configuration. As shown in FIG. 3, the secondary side-feeder 160 can include one or more loss-in-weight gravimetric feeders 166 for dispensing wood fibers and a multiple feeder array 162, such as volumetric auger feeders, for dispensing multiple colorants (or other additives) into the extruder. Thus, two, three, four or more additives may be added from individual hoppers 164 during the extrusion process. As mentioned, these additives may include crumb rubber and/or inorganic fillers such as calcium carbonate, fly ash, and/or talc.

The secondary side-feeder 160 can be disposed in a position downstream of the primary feeder 150 (where the base polymer is introduced) and the first mixing region 170, such that the filler materials and additives are dispensed into the extruder 102 for mixing with the base polymer in the second (relatively low kneading and shear) mixing region 172. Introduction of the filler material and additives at a common zone may present particular advantages. For example, the downstream shearing and kneading effect of the extrusion screws 110, 112 on the fibers and additives is less than the upstream effect on the base materials, thereby providing a thoroughly mixed composite material (i.e., including the base polymer and filler materials).

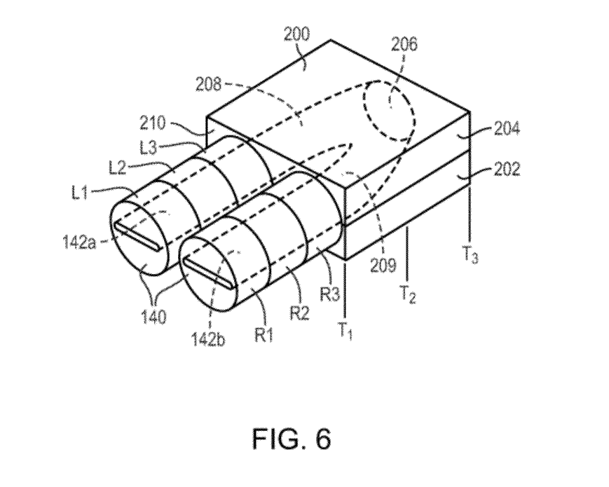

As shown in FIGS. 4A and 6, the system may include a Y-block adapter 200 disposed at a distal end 126 of the extruder 102. The Y-block adapter 200 includes two adapter segments 202, 204 divided into three temperature zones, approximately defined by locations T1, T2, T3. Heating is performed by heating cartridges. The Y-block adapter 200 defines a flow channel 206, that divides flow from the internal cavity 122 of the extrusion barrel 120 into two discrete flow paths 208, 209.

The system 100 also includes an extrusion die 140 disposed at a distal end 210 of the adapter 200, as depicted in FIG. 6. The extrusion die 140 may define a pair of extrusion channels 142a, 142b, each corresponding to an associated one of the flow paths 208, 209, for forming, in tandem, a pair of extruded products (i.e., extrudates) each having a predetermined profile or shape (i.e., corresponding to a shape of the extrusion channels 142a, 142b). Each of the extrusion channels 142a, 142b includes up to three (or more) discrete segments L1-L3, corresponding to channel 142a, and R1-R3, corresponding to channel 142b. These discrete segments L1-L3, R1-R3 smoothly transition the geometry of the cylindrical flow paths 208, 209 along the extrusion channels 142a, 142b to prevent introduction of air bubbles, creation of low flow or high pressure areas, etc. Each of L1-L3 and R1-R3 comprise discrete temperature zones and are heated using individual heaters.

Referring again to FIG. 3, a base mixture 190 includes a base polymer (in one embodiment, a polyethylene mixture including, for example, virgin high density polyethylene (HDPE), recycled HDPE, and/or reprocessed HDPE), and other additives (e.g., base colorant(s), internal processing lubricants, flame retardants, etc.), generally in the form of solid particles, such as powders and/or pellets. In one embodiment, the base mixture 190 is dispensed from the supply station 150 from a main extruder hopper 156 into the feed zone 130 of the extruder 102 at a total feed rate of between about 400 lb/hr to about 2000 lb/hr. Other suitable base polymers include polypropylene, medium density polyethylene, low density polyethylene, linear low density polyethylene, and PVC, when using a counter-rotational twin-screw extruder. In one example, regrind polymer, reprocessed polymers, and recycled polymer (e.g., carpet waste) may be added along with the base polymer, or as a substitute for virgin base polymer. The base mixture 190 is heated by electrical heating elements, and dispersed (i.e., the polymer particles and additive particles are mixed and broken down) as it is conveyed through the extrusion barrel 120 from the feed zone 130 towards the extrusion die 140 with the extrusion screws 110, 112 at a feed rate of between about 400 lb/hr and about 2000 lb/hr.

As mentioned above, the extrusion screws 110, 112 define twelve discrete processing zones Z1-Z12, wherein the first six processing zones Z1-Z6 form a first mixing region 170 (for relatively high kneading and shearing) and the last six zones Z7-Z12 form a second mixing region 172 configured for relatively low shearing and mixing. High and low temperatures used in various embodiments of the invention are exhibited in Table A-1, although higher or lower temperatures than those depicted are contemplated. As shown in Table A-1, the base mixture 190 is heated from a temperature of about 30° C. (ambient, at zone Z0) to about 240° C. as it is conveyed along the first four (i.e., Z1-Z4) of these processing zones, and gradually cooled before exiting the first mixing region 170, thereby forming a thoroughly mixed molten plastic material. At this point in the process, the molten material is a composite of the base polymer, i.e., high density polyethylene, and additives.

Still other materials, such as filler materials (wood or natural fibers) and colorants can be added to achieve the desired physical properties and appearance effects. The wood or natural fibers give the resultant WPC the desired stiffness, rigidity, appearance, or other properties required of a commercially successful product. The colors are for appearance effects.

Referring again to FIGS. 3, 4A, and 4B, a plurality of natural fibers 192, such as, for example, wood fibers, hemp, kenaf, abaca, jute, flax, and rice hulls (e.g., ground rice hulls), and one or more additives, are metered into the extruder 102 through the one or more secondary side-feeders 160 for mixing with the molten polymer materials. The natural fibers 192 and optional additives 194 are introduced into the extruder 102 in an area proximate the sixth processing zone Z6. The fibers 192 and additives/colorants 194 are then mixed with the molten base material 190 as it is conveyed through the second (relatively low shearing) mixing region 172. As the molten composite is conveyed along about the tenth processing zone Z10, it is first compressed under vacuum of about 29 in-Hg. Then, the material is allowed to expand, allowing moisture to rise to an outer surface for evaporation. The material is then compressed again under vacuum of about 25 to about 29 in-Hg. This transition region Z10 removes moisture as the material is conveyed toward the extrusion die. The screw segments 116 are selected as described in greater detail above, to provide high distribution of the fibers 192 in the composite material 190, while at the same time inhibiting over mixing of the colorants 194 with the composite material. In this embodiment, the natural fibers 192 are metered into the extruder 102 at a rate of about 400 lb/hr or less to about 2000 lb/hr or more. The additives that may be introduced at this point into the extruder are usually much smaller in quantity, being in the range of 5 lb/hr to about 50 lb/hr. The exceptions being molder and/or cutter trim, which may be added at rates of about 50 lb/hr to about 300 lb/hr, and recycled carpet waste which may be added at rates of about 50 lb/hr to about 500 lb/hr. The recycled carpet waste may be in granule form, as described in U.S. Patent Application Publication No. 2008/0128933, the disclosure of which is hereby incorporated by reference herein in its entirety. The granules may be from about 4 mesh to about 100 mesh, from about 5 mesh to about 40 mesh, or preferably from about 8 mesh to about 16 mesh.

All the feeders, both for the main entry port and for secondary port(s), are controlled through a programmable logic controller 180. Additionally, the controller 180 also controls the coextruders 300 and related components, as well as the downstream components (e.g., the puller 318, saws 320, etc.). The amount of each material added is controlled for optimum formulation control, allowing for the use of specific materials in specific amounts to control the physical properties of the extruded composite product.

The composite material is gradually cooled from the temperature when exiting the first mixing region 170 to a temperature of about 170° C. to about 180° C. as it is conveyed along the second mixing region 172 towards the extrusion die 140. This cooling allows the fibers 192 to mix with the molten composite material 190 without being burned or destroyed by the process temperatures. The material is compressed as it is conveyed from zone Z11 to zone Z12, thus allowing pressure to build-up, e.g., between about 7 bar to about 30 bar at the extruder exit and increased to 10 bar to 80 bar at the melt pump exit, in order to force the material through the die.

In one embodiment, an adapter and melt pump are located at the distal end 126 of the extrusion system 100. The melt pump levels pressure of the extruded material within the system 100. Table A-1 also depicts the temperature and pressure ranges of the material at the melt pump. The composite material is then fed into the Y-block adaptor (if present) where it is heated to a temperature of about 165° C. and split into two separate flows, which are forced through corresponding extrusion ports 142a, 142b of the extrusion die 140 to form a pair of extruded composite profiles to be coextruded with a capstock. The coextrusion die 312 is located at the exit face 140a, 140b (as depicted in FIG. 6) of each extrusion die 140, and is described in more detail below. Similarly, the internal pressure in the die(s) depends on whether the extrusion is being done on a single die or double die arrangement.

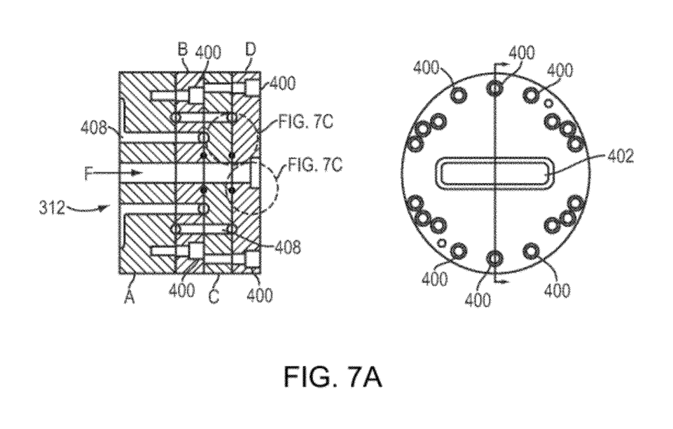

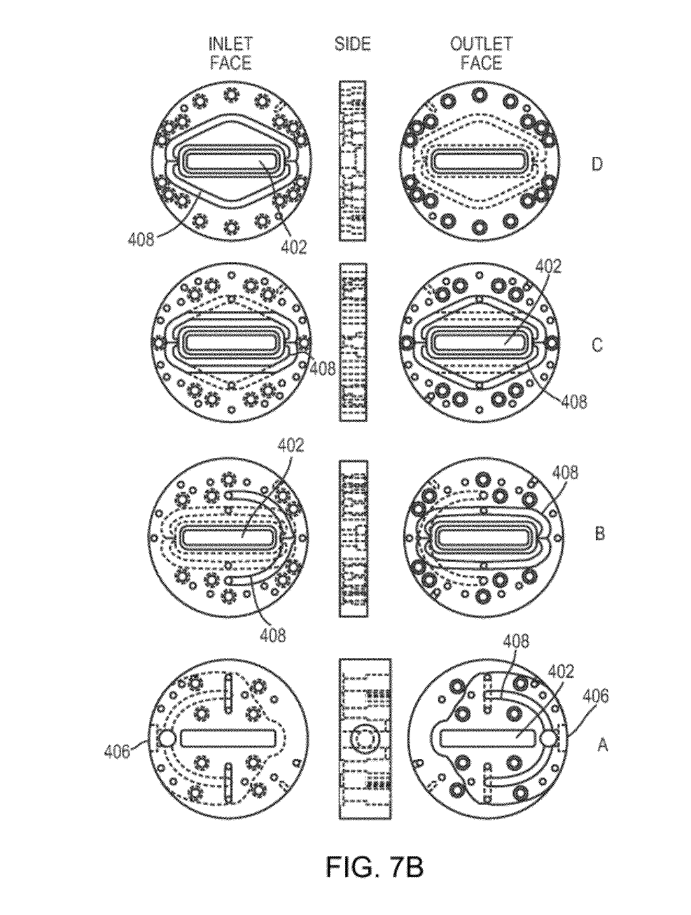

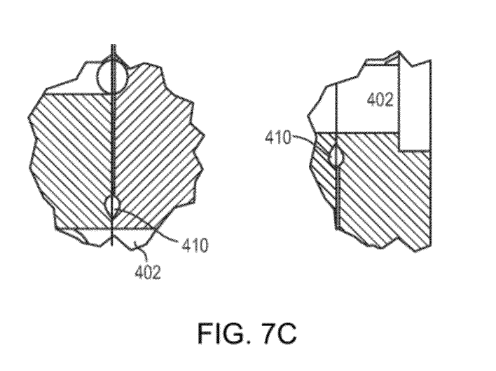

FIGS. 7A-7C are various views of a coextrusion die 312 in accordance with one embodiment of the invention. The coextrusion die 312 is a laminated four plate die with discrete sections A-D. Certain holes 400 in each die section accommodate bolts or locator pins to align the individual sections. Each section of the die 312 defines a channel 402 sized to accommodate the extruded core material, which flows through the die 312 in a direction F. Two coextrusion dies are used. The inlet face of section A is secured to the exit face 140a, 140b of each extrusion die 140. Molten capstock material is introduced to the die 312 via an inlet 406 in section A. The molten capstock material flows through a plurality of channels 408. Each channel 408 corresponds generally to a matching channel 408 on an adjacent abutting section of the die 312. For example, the channel configuration on the outlet face of section B corresponds substantially to the channel configuration on the inlet face of section C. Ultimately, the molten capstock material is introduced to the extruded core material at locations 410 at the interfaces between sections B and C and sections C and D and metered onto the passing outer surfaces of the core extrudate. These locations 410 are shown in more detail in the enlarged partial figures depicted in FIG. 7C, as indicated by the circular overlays designated FIG. 7C in FIG. 7A.

A number of potential capstock formulations were prepared and tested to determine performance characteristics. Table B-1 identifies a number of formulations, identified as samples LCC-12, LCC-15, COF-2, COF-3, COF-4, COF-5, COF-6, COF-7, COF-8, COF-9, COF-10, and COF-11, prepared in accordance with the invention. Formulations are provided in percentage of each component, by weight of the total formulation. As the table indicates, the capstock polymer for each sample was HDPE, and elastomers and plastomers included VLDPE, metallocene PE, a propylene based elastomer, EMA, EPDM, and SEBS TPE.

Test results for the various sample formulations are also provided in Table B-1. ASTM standard tests were performed to obtain the results identified below: Melt Index Test (ASTM D-1238); Shore D Hardness Test (ASTM D-2240); Gardner Impact Test (ASTM D-5420); Tensile Strength Test (ASTM D-412); Elongation Test (ASTM D-412); and Flexural Modulus Test (ASTM D-790). In sum, samples performed acceptably during these tests.

TABLE B-1
Exemplary Formulations

| | LCC-12 | LCC-15 | COF-2 | COF-3 | COF-4 | COF-5 | COF-6 | COF-7 | COF-8 | COF-9 | COF-10 | COF-11 |
|---|---|---|---|---|---|---|---|---|---|---|---|---|
| | % wt | % wt | % wt | % wt | % wt | % wt | % wt | % wt | % wt | % wt | % wt | % wt |
| Polymer | | | | | | | | | | | | |
| HDPE Capstock Polymer | 85.0 | 90.0 | 90.0 | 80.0 | 90.0 | 80.0 | 80.0 | 90.0 | 80.0 | 90.0 | 80.0 | 90.0 |
| VLDPE | 15.0 | | | | | | | | | | | |
| Metallocene PE | | 10.0 | | | | | | | | | | |
| Propylene based | | | 10.0 | 20.0 | | | | | | | | |
| Elastomer | | | | | | | | | | | | |
| EMA (Ethylene Acrylic | | | | | 10.0 | 20.0 | | | | | | |
| Ester) | | | | | | | | | | | | |
| EPDM Elastomer | | | | | | | 10.0 | 20.0 | | | | |
| SEBS TPE | | | | | | | | | 10.0 | 20.0 | | |
| SEBS TPE | | | | | | | | | | | 10.0 | 20.0 |
| Total Base + Modifier | 100.0 | 100.0 | 100.0 | 100.0 | 100.0 | 100.0 | 100.0 | 100.0 | 100.0 | 100.0 | 100.0 | 100.0 |
| Additives | | | | | | | | | | | | |
| Color/Stabilizers | | | | | | | | | | | | |
| Fire Retardants | | | | | | | | | | | | |
| Anti-Statics | | | | | | | | | | | | |
| Mineral Fillers | | | | | | | | | | | | |
| Total Additives | 0.0 | 0.0 | 0.0 | 0.0 | 0.0 | 0.0 | 0.0 | 0.0 | 0.0 | 0.0 | 0.0 | 0.0 |
| Test Results | | | | | | | | | | | | |
| Gardner Impact, | 213.0 | 214.0 | 212.0 | | | | | | | | | |
| in.-lb.@RT | | | | | | | | | | | | |
| Surface Hardness, | 67.0 | 66.0 | 76.0 | | | | | | | | | |
| Shore D | | | | | | | | | | | | |
| Melt Index, Condition E | 0.8 | 0.7 | | | | | | | | | | |
| Melt Index, Condition L | | | 5.3 | | | | | | | | | |
| Coefficient of Friction | 1.6 | 1.3 | 2.0 | 2.4-3.6 | 1.44-2.08 | 1.44-1.84 | 1.44-1.52 | 2.6-2.8 | | | | |
| Tensile Strength, psi | 2600.0 | 3200.0 | 4500.0 | | | | | | | | | |
| Elongation, % | 14.6 | 14.3 | 15.9 | | | | | | | | | |
| Stiffness, psi | 92500.0 | 79750.0 | 103600.0 | | | | | | | | | |
| Adhesion to HDPE, lb. | 74.3 | 66.0 | 64.6 | | | | | | | | | |

Table B-2 identifies additional formulations for capstocks that include various percentages of HDPE and a plastomer (VLDPE or Metallocene PE) or an elastomer (propylene based elastomer). Measured performance data (in accordance with the ASTM standard tests described above with regard to Table B-1) are provided along with desired or target performance values. As indicated in the table, the measured performance values meet or exceed the target values for each formulation, for most of the tests.

TABLE B-2
Capstock Formulations

| | LCC-12 | LCC-15 | COF-2 | COF-3 | Property |
|---|---|---|---|---|---|
| | % wt | % wt | % wt | % wt | Targets |
| Polymer | | | | | |
| HDPE Capstock Polymer | 85.0 | 90.0 | 90.0 | 80.0 | |
| VLDPE | 15.0 | | | | |
| Metallocene PE | | 10.0 | | | |
| Propylene based Elastomer | | | 10.0 | 20.0 | |
| EMA (Ethylene Acrylic Ester) | | | | | |
| EPDM Elastomer | | | | | |
| SEBS TPE | | | | | |
| SEBS TPE | | | | | |
| Total Base + Modifier | 100.0 | 100.0 | 100.0 | 100.0 | |
| Additives | | | | | |
| Color/Stabilizers | | | | | |
| Fire Retardants | | | | | |
| Anti-Statics | | | | | |
| Mineral Fillers | | | | | |
| Total Additives | 0.0 | 0.0 | 0.0 | 0.0 | |
| Test Results | | | | | |
| Gardner Impact, in.-lb.@RT | 213.0 | 214.0 | 212.0 | | 150 min. |
| Surface Hardness, Shore D | 67.0 | 66.0 | 76.0 | | 62 min. |
| Melt Index, Condition E | 0.8 | 0.7 | | | 0.9 |
| Melt Index, Condition L | | | 5.3 | | |
| Coefficient of Friction | 1.6 | 1.3 | 2.0 | 2.4-3.6 | |
| Tensile Strength, psi | 2600.0 | 3200.0 | 4500.0 | | 3000.0 |
| Elongation, % | 14.6 | 14.3 | 15.9 | | 20.0 |
| Stiffness, psi | 92500.0 | 79750.0 | 103600.0 | | 50,000 |
| Adhesion to HDPE, lb. | 74.3 | 66.0 | 64.6 | | 60 min. |

Table C-1 depicts the ranges of various components that may be utilized in capstocked composite formulations in accordance with the present invention. The ranges provided in Table C-1, and all the tables herein, are approximate; acceptable ranges may be lower and higher than those actually enumerated. Any of the capstock formulations depicted in Tables B-1 and B-2 may be utilized with the WPCs or solely plastic cores described herein. Specifically, materials introduced via the main feed may include HDPE pellets (as a base polymer), lubricants, and colorants. Other components, such as regrind (in pulverized or flake form), repro, and/or recycled polymers to replace at least a portion of the HDPE pellets used as the base polymer, also may be introduced via the main feed. The regrind material is post-industrial or post-consumer polyethylene materials or a combination of the two. The repro is reprocessed extrusion materials generated in the production of the extruded product. The recycled polymer may be recycled carpet waste, plastic bags, bottles, etc. The side feed, located downstream from the main feed, may be utilized to introduce wood filler and other additives, if desired.

TABLE C-1
Formulations for Extruded Composites with Coextruded Capstock.

Range

| | | |
|---|---|---|
| | Low | High |
| Material | % | % |

Main Extruder

| | | |
|---|---|---|
| Main Feed | | |
| Base Polymer | 1 | 100 |
| Regrind (pulverized) | 0 | 50 |
| Regrind (flake) | 0 | 50 |
| Repro | 0 | 50 |
| Lubricant | 0 | 9 |
| Color (incl. UV/AO) | 0 | 2 |
| Side Feed | | |
| Wood Filler | 0 | 70 |

Co-Extruder

| | | |
|---|---|---|
| Capstock Polymer | 1 | 100 |
| Plastomer | 0 | 50 |
| Elastomer | 0 | 50 |
| Color (incl. UV/AO) | 0 | 4 |
| Variegated Color | 0 | 4 |
| Wood Filler | 0 | 25 |
| Biocide | 0 | 2 |
| Fire Retardant | 0 | 30 |
| Other Additives | 0 | 10 |

It has been discovered that, surprisingly, polymeric capstocks containing plastomers and/or elastomers, as described herein, may be coextruded with WPCs to produce an extruded product having enhanced performance and appearance characteristics, without the need to alter the formulation of the standard, core wood-plastic composite, and can be processed in the extruder using the same screw profiles and zone parameters. Additionally, specific examples of capstocked WPCs manufactured in accordance with the component ranges of Table C-1 and the process ranges of Table A-1 are depicted in Table D-1.

Table C-1 illustrates the range of individual components that may be used to produce acceptable capstocked WPCs. As a weight percentage, the capstock may include from about 1% to about 100% of capstock polymer, from about 0% to about 50% of plastomer, and from about 0% to about 50% of elastomer. In certain embodiments, the weight percentage of capstock polymer in the capstock is from about 20% to about 80%, from about 30% to about 60%, from about 30% to about 50%, from about 70% to about 99%, from about 75% to about 95%, from about 80% to about 95%, or about 90%. Likewise, in certain embodiments, the weight percentage of elastomer in the capstock is from about 1% to about 30%, from about 5% to about 20%, or about 10%. Similarly, in certain embodiments, the weight percentage of plastomer in the capstock is from about 1% to about 30%, from about 5% to about 20%, or about 10%. In another embodiment, the weight percentage of elastomer and plastomer, combined, in the capstock is from about 1% to about 30%, from about 5% to about 20%, or about 10%. An embodiment of the capstock formulation utilizing about 10% plastomer or elastomer and about 90% HDPE has displayed particularly desirable commercial properties. In this last formulation, adhesion is very high, while scratch resistance and ability to withstand damage is not severely impacted.

Further, different types of lubricant perform equally well in the processing. For example, where both a “one-pack” or combined specialty lubricant is used as well as a more conventional individual lubricant package (e.g., zinc stearate, EBS wax, etc.), the materials processed acceptably, regardless of the lubricant approach to formulating. Within the ranges of components depicted in Table C-1, certain formulations have proven particularly desirable for commercial purposes. One such embodiment of the core material is about 42% polymer, about 7.5% lubricant, about 1% color, and about 49% wood filler. The capstock material for this embodiment is about 85% HDPE polymer, about 10% plastomer, and about 5% color, including stabilizers.

The capstock may also include an antistatic agent, such as an ethoxylated amine. The antistatic agent may be an internal antistatic agent or an external antistatic agent. In certain embodiments, a weight percentage of antistatic agent in the capstock is from about 1% to about 5%. For example, the weight percentage of antistatic agent may be about 1.2%.

The capstock layer may also include crumb rubber. A weight percentage of crumb rubber in the capstock may be up to about 50% or 75%, but typically in a range from about 5% to about 35%. For example, the weight percentage of crumb rubber in the capstock may be about 10%. The crumb rubber may have a mesh size ranging from about 10 to about 100, or from about 20 to about 40, or about 30. The crumb rubber may be of any grade, for example from No. 1 to No. 5, or from No. 1 to No. 3. The crumb rubber is preferably of grade No. 2 or No. 3.

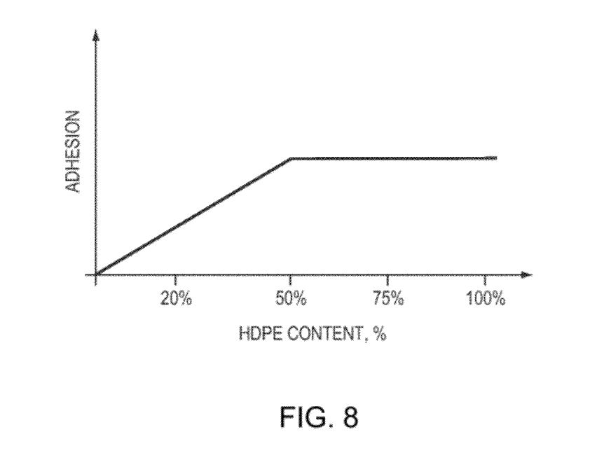

It has also been determined that high percentages of capstock polymer used in the formulation result in increased adhesion, even while retaining acceptable weatherability. FIG. 8 depicts the relationship between the percentage of HDPE in the formulation and adhesion strength. Notably, while adhesion increases steadily as HDPE is increased to about 50%, further increases in HDPE display little, if any, improvement in adhesion.

The downstream mechanical operations, beyond the coextruder die arrangement, follow the same pattern as the formulation and processing conditions, in that, the coextruded, capstocked composite has minimal effect on processing of the final product relative to the uncapstocked, wood-plastic composite. The extruded product can be cut using conventional traveling saw or other equipment Likewise, the extruded board can be molded and/or embossed using standard equipment. In the case of molding, a blade cutter can be used to change the surface appearance to a grooved or sanded appearance. These formulations also are capable of being hot surface embossed. An embossing roll using either an internal hot oil system to heat the surface of the embossing roll or an infra-red heating system to heat the roll surface both emboss the board, or ambient temperature roll surfaces may be pressed on a hot co-extrusion surface.

Coextruded composite formulations yield equivalent flexural strength and stiffness to the standard uncapstocked composites. Upon extrusion and cooling, the finished composite materials may be tested and inspected to ensure acceptable performance and geometry. Multiple parameters may be evaluated, including visual appearance, dimensional control, physical properties, water absorption, etc.

Visually, the composites are inspected for cracks along the edges or gaps within the material internally (e.g., the composites may be cut, bored, etc., to confirm consistent distribution of the materials, adhesion of the capstock, etc.). Dimensional control inspections, both static and when subject to loading, determine whether the composites adequately resist warping, bending, or twisting. Samples may be tested, for example under ASTM-D790, to determine specific physical properties, such as stress, displacement, modulus of elasticity, and load.

### EXAMPLES

Table D-1 depicts the formulations for three capstocked WPCs, identified as samples 10080602A, 10080602B, and 10080602C, manufactured in accordance with the invention. The core material included HDPE pellets, reprocessed WPC products, regrind (recycled polyethylene), lubricant, and color. Maple, maple/oak blends, or oak wood flour was added to the polymer mixture, which was then coextruded with a capstock. The core formulation for each of the three samples was identical. The capstock for each sample included a package of HDPE and color/stabilizer. The capstock for sample 10080602A did not include a plastomer or an elastomer, while the capstocks for samples 10080602B and 10080602C included a plastomer (i.e., Metallocene PE and VLDPE, respectively) but no elastomer.

The capstocked WPC samples were subjected to a Hot/Cold Water Exposure Test that included immersing the samples in water at ambient temperature (i.e., between about 68° F. and about 78° F.) for 28 days, followed by immersing the samples for an additional 28 days in water at approximately 150° F. After both water immersion periods, the samples were evaluated for changes in appearance and dimensions.

The test results indicated that the capstocked samples absorb very little water and experience minimal water damage, especially when compared to test results for uncapstocked WPCs. For example, unlike the capstocked WPCs, the ends and edges of uncapstocked WPCs degrade, fray, and absorb moisture. In addition, while some cracking appeared in the capstocked WPCs, it was significantly less than the amount of cracking that appeared in the uncapstocked WPCs. Further, visual results from the test display similar differences, with the capstocked samples experiencing minimal visual degradation and the uncapstocked WPCs experiencing some visual degradation. Prior to the test, it was expected that the uncapstocked WPC would be able to retain its shape better than the capstocked WPC, since it could expand freely in all directions. The contrary results from the test are surprising in that the capstocked WPC was better able to withstand the testing procedures.

Mold and mildew resistance is improved over uncapstocked WPCs through the use of biocides, which need only be incorporated into the capstock on the surface of the composite core. In addition, ultra-violet and oxygen stabilizers can be used to protect the pigmentation of the capstock compound, allowing for improved aging properties of the capstocked WPC.

TABLE D-1
Co-extruded Capstocked Materials With and Without Plastomers

| | Production | | Plastomer | | Elastomer | |
|---|---|---|---|---|---|---|
| | Control | | Modified | | Modified | |
| | Board | | Capstock | | Capstock | |
| | 10080602 A | | 10080602 B | | 10080602 C | |
| Material | lb. | % | lb. | % | lb. | % |
| Main Feed | | | | | | |
| HDPE (pellets) | 50.0 | 9.8 | 50.0 | 9.8 | 50.0 | 9.8 |
| Same Color Repro | 0.0 | 0.0 | 0.0 | 0.0 | 0.0 | 0.0 |
| Mixed Color Repro | 145.0 | 28.4 | 145.0 | 28.4 | 145.0 | 28.4 |
| Regrind PE | 100.0 | 19.6 | 100.0 | 19.6 | 100.0 | 19.6 |
| Lubricant | 38.0 | 7.5 | 38.0 | 7.5 | 38.0 | 7.5 |
| Color/Stabilizer | 7.0 | 1.4 | 7.0 | 1.4 | 7.0 | 1.4 |
| Side Feed | | | | | | |
| Maple/Oak | 170.0 | 33.3 | 170.0 | 33.3 | 170.0 | 33.3 |
| Total Board | 510.0 | 100.0 | 510.0 | 100.0 | 510.0 | 100.0 |
| Capstock | | | | | | |
| Capstock Polymer + | 30.0 | 100.0 | 25.8 | 80.8 | 27.2 | 85.3 |
| Color/Stab. | | | | | | |
| Plastomer (Metallocene PE) | 0.0 | 0.0 | 4.2 | 13.2 | 0.0 | 0.0 |
| Plastomer (VLDPE) | 0.0 | 0.0 | 0.0 | 0.0 | 2.8 | 8.8 |
| Secondary Color | 0.0 | 0.0 | 0.8 | 2.5 | 0.8 | 2.5 |
| Tertiary Color | 0.0 | 0.0 | 1.1 | 3.5 | 1.1 | 3.5 |
| Total Capstock | 30.0 | 100.0 | 31.9 | 100.0 | 31.9 | 100.0 |
| TOTAL | 540.0 | | 541.9 | | 541.9 | |

In addition to the formulas described above in Table D-1, it is contemplated that the properties of the capstock, and indeed the entire board, may be modified with additional materials, added to the capstock and/or the core. Possible additional materials include, but are not limited to, biocides, fire retardants, lubricants (e.g., slack wax or other waxes), slip resistance modifiers, and aesthetics modifiers.

Alternatively or additionally, the natural fibers can be replaced in whole or in part with synthetic fibers, such as those present in recycled carpet waste or other virgin, recycled, or reclaimed sources. See, for example, U.S. Patent Application Publication No. 2008/0213562 and U.S. Patent Application Publication No. 2008/0064794, the disclosures of which are hereby incorporated by reference herein in their entireties. The carpet waste may include carpet fibers of, for example, polypropylene, polyester, and/or NYLON. In some embodiments, the carpet fibers in the composite are melted. For example, the composite may include a combination of melted carpet fibers and unmelted carpet fibers. Generally, the melted carpet fibers are fibers that include or consist of lower melting point materials such as polypropylene. The unmelted carpet fibers generally include or consist of higher melting point materials such as polyester or NYLON. In one implementation, the composite includes polypropylene (e.g., melted polypropylene carpet fibers) and unmelted polyester and/or NYLON fibers.

When carpet fibers (melted or unmelted) are included in the composite, the carpet fibers may be substantially of a single type. For example, the carpet fibers may be substantially polypropylene, polyester, or NYLON. In one embodiment, the carpet fibers are substantially polypropylene with trace aments of polyester and/or NYLON.

Carpet generally includes a mixture of fibers and adhesive. Used carpet or carpet waste may also include dirt and other impurities. In addition to including the carpet fibers, the composite may incorporate the adhesive, the dirt, and/or the other impurities. For example, the composite may include the adhesive, which may be or may include a mixture of latex and calcium carbonate. In alternative embodiments, the carpet materials are processed (e.g., using filters or separators) to substantially remove the adhesive, the dirt, and/or other impurities. In that case, the composite may include carpet fibers (melted or unmelted) and only small amounts of other carpet components.

In certain embodiments, the core and/or capstock of the composite include any type of inorganic filler, such as fly ash, talc, and/or calcium carbonate. See, for example, U.S. Provisional Patent Application No. 61/371,333 and U.S. Patent Application Publication No. 2012/0077890, the disclosures of which are hereby incorporated by reference herein in their entireties.

As mentioned, in some embodiments, the composite includes crumb rubber. The crumb rubber may be included within the core and/or the capstock of the composite.

The materials (e.g., base polymer, fibers, fillers, additives, etc.) within the core or capstock of the composite are generally uniformly and homogeneously distributed. As a result, the material and physical properties of the core or the capstock, such as density, specific gravity, or modulus, generally do not vary or do not vary substantially within the core or the capstock, respectively.

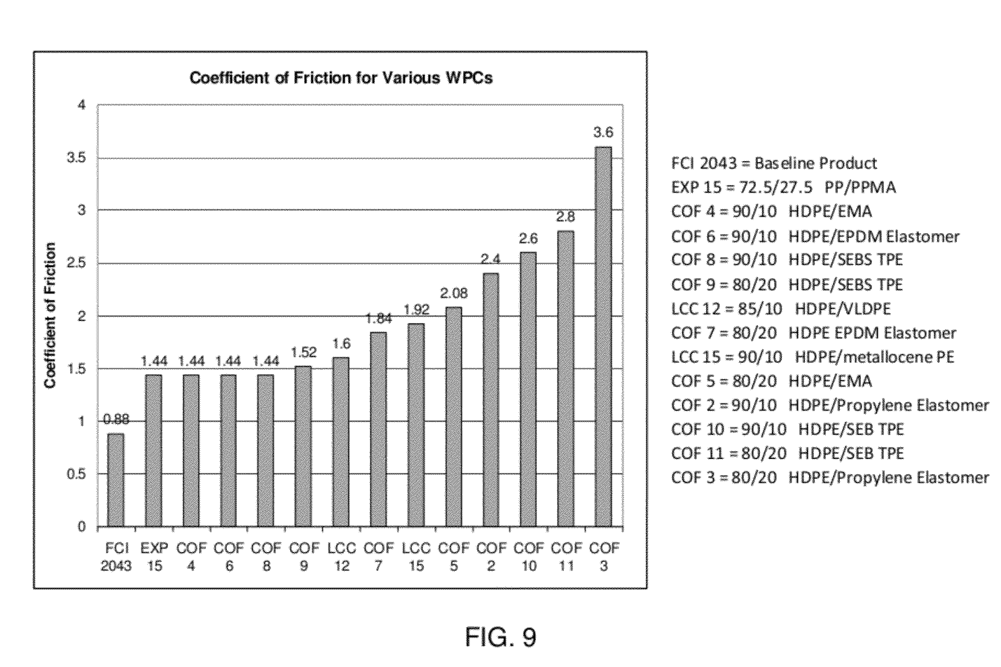

FIG. 9 is a plot depicting the coefficient of friction for the capstock formulations listed in Table B-1. The results indicate that the highest coefficients of friction were obtained with formulations that included an elastomer (e.g., COF-3, COF-10, and COF-11). Each of the samples had a higher coefficient of friction than a baseline WPC product, which was HORIZON® decking, manufactured by Fiberon, LLC of New London, N.C. A high coefficient of friction may be desirable to improve traction.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations described herein are intended as illustrative and in no way limiting. Similarly, although physical explanations have been provided for explanatory purposes, there is no intent to be bound by any particular theory or mechanism, or to limit the claims in accordance therewith. For example, the core may be foamed, with or without natural and/or synthetic fibers.

What is claimed is:

1. An extruded composite adapted for use as a building material, the extruded composite comprising:
a core comprising a base polymer and a filler material in a substantially homogeneous mixture; and
a capstock disposed on at least a portion of the core, the capstock comprising at least one of an elastomer and a plastomer,
wherein, when the capstock comprises the plastomer, at least one of
(a) the extruded composite is substantially free of a compatibilizer; and
(b) when the filler material comprises a natural fiber, the natural fiber comprises a moisture content greater than about 0.5 percent.

2. The extruded composite of claim 1, wherein the base polymer is selected from the group consisting of polypropylene, polyethylene, HDPE, MDPE, LDPE, LLDPE, and combinations thereof.

3. The extruded composite of claim 1, wherein the filler material comprises natural fiber selected from the group consisting of wood chips, wood flour, wood flakes, sawdust, flax, jute, hemp, kenaf, rice hulls, abaca, and combinations thereof.

4. The composite of claim 1, wherein the capstock further comprises a capstock polymer, wherein the capstock polymer and the at least one of the elastomer and the plastomer comprise a substantially homogeneous mixture.

5. The extruded composite of claim 4, wherein the base polymer comprises a first polymer and the capstock polymer comprises the first polymer.

6. The extruded composite of claim 5, wherein the first polymer is HDPE.

7. The extruded composite of claim 4, wherein the capstock further comprises an additive selected from the group consisting of a colorant, a variegated colorant, a UV stabilizer, an antioxidant, an antistatic agent, a biocide, and a fire retardant.

8. The extruded composite of claim 1, wherein the core comprises from about 35% to about 50% base polymer, by weight.

9. The extruded composite of claim 1, wherein the capstock comprises about 1% to about 30% of the at least one of the elastomer and the plastomer, by weight.

10. The extruded composite of claim 1, wherein the capstock comprises about 5% to about 20% of the at least one of the elastomer and the plastomer, by weight.

11. The extruded composite of claim 4, wherein the capstock comprises about 70% to about 99% capstock polymer, by weight.

12. The extruded composite of claim 4, wherein the capstock comprises about 80% to about 95% capstock polymer, by weight.

13. The extruded composite of claim 1, wherein the capstock comprises a thickness of about 0.012 inches to about 0.040 inches.

14. The extruded composite of claim 1, wherein the capstock comprises a thickness of about 0.015 inches to about 0.020 inches.

15. The extruded composite of claim 1, wherein the capstock comprises the elastomer, and wherein the elastomer comprises at least one of a propylene based elastomer, an ethylene propylene diene monomer, a three block thermoplastic elastomer, and a two block thermoplastic elastomer.

16. The extruded composite of claim 1, wherein the capstock comprises the plastomer, and wherein the plastomer comprises at least one of very low density polyethylene, metallocene polyethylene, and ethylene methacrylate.

17. The extruded composite of claim 1, wherein the filler material comprises an inorganic filler selected from the group consisting of calcium carbonate, fly ash, and talc.

18. The extruded composite of claim 1, further comprising crumb rubber.

19. A method of manufacturing an extruded composite adapted for use as a building material, the method comprising the steps of:
providing a base polymer;
providing a filler material;
mixing and heating the base polymer and the filler material to produce a base mixture comprising a substantially homogeneous melt blend;
providing a capstock material comprising at least one of an elastomer and a plastomer; and
coextruding the capstock material onto at least a portion of the base mixture through a die to form an extruded profile,
wherein, when the capstock material comprises the plastomer, at least one of
(a) the extruded composite is substantially free of a compatibilizer; and
(b) when the filler material comprises a natural fiber, the natural fiber comprises a moisture content greater than about 0.5 percent.

20. The method of claim 19, further comprising the steps of:
providing a capstock polymer; and
mixing and heating the capstock polymer and the capstock material to produce a capstock mixture comprising a substantially homogeneous melt blend.

21. The method of claim 20, wherein the base polymer comprises a first polymer and the capstock polymer comprises the first polymer.

22. The method of claim 21, wherein the first polymer is selected from the group consisting of polypropylene, polyethylene, HDPE, MDPE, LDPE, LLDPE, and combinations thereof.

23. The method of claim 21, wherein the first polymer is HDPE.

24. The method of claim 20, further comprising the steps of:
providing an additive comprising at least one of a colorant, a variegated colorant, a UV stabilizer, an antioxidant, an antistatic agent, a biocide, and a fire retardant; and
mixing and heating the capstock material, the capstock polymer, and the additive to produce a capstock mixture comprising a substantially homogeneous melt blend.

25. The method of claim 20, further comprising the step of cooling the extruded profile by passing the extruded profile through a liquid.

26. The method of claim 20, wherein coextruding occurs in a single step from constituent materials.

27. The method of claim 20, wherein the capstock material comprises the elastomer, and wherein the elastomer comprises at least one of a propylene based elastomer, an ethylene propylene diene monomer, a three block thermoplastic elastomer, and a two block thermoplastic elastomer.

28. The method of claim 20, wherein the capstock material comprises the plastomer, and wherein the plastomer comprises at least one of very low density polyethylene, metallocene polyethylene, and ethylene methacrylate.

29. The method of claim 20, wherein the filler material comprises an inorganic filler selected from the group consisting of calcium carbonate, fly ash, and talc.

30. The method of claim 20, further comprising the step of providing crumb rubber for incorporation in at least one of the base mixture and the capstock material.
